(19) United States
(12) Patent Application Publication
(10) Pub. No.: US 2019/0080390 A1
(43) Pub. Date: Mar. 14, 2019

(54) SYSTEM AND METHOD FOR APPAREL ONLINE SHOPPING

(71) Applicant: TIGER FOX MARKETING LTD, Road Town, Tortola (VG)

(72) Inventor: Eliyahu CHERVINSKI, London (GB)

(73) Assignee: TIGER FOX MARKETING LTD., Road Town, Tortola (VG)

(21) Appl. No.: 16/083,294

(22) PCT Filed: Apr. 4, 2017
(86) PCT No.: PCT/IL2017/050408

§ 371 Date: Sep. 7, 2018

Related U.S. Application Data
(60) Provisional application No. 62/317,722, filed on Apr. 4, 2016.

(51) Int. Cl. G06Q 30/06; G06Q 30/02

(52) U.S. Cl. CPC G06Q 30/0643; G06Q 30/0621; G06Q 30/0214; G06Q 30/0623

(57) ABSTRACT

A system and method that enables users to publish photographs and videos wearing apparel items and enter personal information regarding the apparel and user measures. Other users can then search the system for desired apparel items and be shown photographs and videos of users with similar body types wearing those apparel items. If a user likes the way the apparel looks on a person with similar body type, the system enables the user to make an online purchase of that apparel. The user that has published the photograph will then get a commission as an affiliate of the apparel brand.

### TECHNICAL FIELD

The present invention relates to online shopping in general, and in particular to systems and methods for online shopping of apparel.

### BACKGROUND ART

Shopping for fashion items such as clothing, accessories and jewelry is a very popular activity that is performed both in retail (offline) and online. Online shopping is very convenient since a user can access from the comfort of his computer or mobile device a very large selection of fashion items, that in many times are more affordable online than in retail.

One of the main challenges of online shopping for apparels is the shopper cannot try the actual item and thus risks purchasing an apparel that may not fit or that would fit the shopper but will not look good on him or her.

There is thus a need in the industry to give online shoppers for apparels tools that will help them purchase apparels that would fit them and that they would be satisfied with the way it would look on them, thus reducing the return rate of apparel purchased online.

### SUMMARY OF INVENTION

It is an object of the present invention to disclose a system and method for enabling an online shopper to identify apparels that would fit him.

It is another object of the present invention to disclose a system and method for enabling an online shopper to identify and purchase apparels that would fit him.

It is a further object of the present invention to disclose a system and method for enabling an online shopper to identify apparels that would fit his body type and measurements.

It is yet another object of the present invention to disclose a system and method for enabling an online shopper to identify apparels as shown on photographs and/or videos (digital representations) of other people with similar body types and measurements.

It is yet a further object of the present invention to disclose a system and method for enabling an online shopper to identify apparel shown on a photograph or video of a publishing user and purchase the apparel online from a vendor.

It is yet another object of the present invention to disclose a system and method for enabling an online shopper to identify apparel shown on a photograph or video of a publishing user and purchase the same apparel and/or other apparels online from a vendor.

It is yet a further object of the present invention to disclose a system and method for enabling a publishing user to upload photographs showing the publishing user wearing an apparel, and become an affiliate or sub-affiliate of the apparel vendor when an online shopper purchases an apparel from the vendor via the publishing user who uploaded the photograph or video.

The return rate of online apparel purchases is high and in some cases quoted as up to 50% of the purchases. In many cases, the reason users quote when returning a product is because it doesn't fit them or they don't like how it looks on them. The present invention helps online shoppers appreciate how an apparel looks on another person with similar body type and measurements so that online shoppers can make a better decision on whether to purchase an apparel or not.

The present invention relates to a computing system comprising: at least one processor; and at least one memory communicatively coupled to the at least one processor comprising computer-readable instructions that when executed by the at least one processor cause the computing system to implement a method of enabling users to obtain an apparel via a trade transaction, the method comprising:

(i) receiving user profile information comprising at least a masculine or feminine body type;
(ii) receiving in a database digital representations uploaded by users, each digital representation associated with a user and showing the user wearing at least one apparel;
(iii) associating each digital representation with one or more tags. The tags are uploaded by the user uploading the digital representation. Each digital representation needs to have at least one tag;
(iv) showing a shopping user a digital representation of an apparel worn by a matching publishing user, the matching criteria comprising one or more of personal information, body type and one or more tags. The digital representation is found by searching the database by the system or by a shopping user for a digital representation of an apparel worn by a matching publishing user;
(v) presenting the shopping user with an online shopping module to purchase online at least one apparel from a vendor associated with the apparel shown in the digital representation of the publishing user; and
(vi) rewarding the publishing user financially for the purchase of the shopping user.

In another aspect, the present invention relates to a computing system comprising: at least one processor; and at least one memory communicatively coupled to the at least one processor comprising computer-readable instructions that when executed by the at least one processor cause the computing system to implement a method of enabling users to obtain an apparel via a trade transaction, the method comprising:

(i) receiving user profile information comprising at least a masculine or feminine body type;
(ii) receiving in a database digital representations uploaded by users, each digital representation associated with a, a user and showing the user wearing at least one apparel;
(iii) associating each digital representation with one or more tags;
(iv) showing a shopping user a digital representation of an apparel worn by a matching publishing user, the matching criteria comprising one or more of personal information, body type and one or more tags;
(v) enabling the shopping user to obtain at least one apparel associated with the apparel shown in the digital representation of the publishing user by performing a trade transaction.

In some embodiments, users enter at least one body measurement to their profile information.

In some embodiments, users enter at least two body measurement to their profile information.

In some embodiments, users enter at least three body measurement to their profile information.

In some embodiments, the body measurements comprise chest, waist, hips and height.

In some embodiments, the trade transaction is purchasing the apparel shown in the digital representation from the publishing user.

In some embodiments, the trade transaction is purchasing one or more apparels from the vendor (manufacturer or distributor) of the apparel shown in said digital representation.

In some embodiments, the trade transaction comprises purchasing the apparel shown in said digital representation from the manufacturer or distributor of the apparel shown in said digital representation.

In some embodiments, the publishing user gets a commission from the manufacturer or distributor when the shopping user purchases one or more apparels. The publishing user may also be a sub-affiliate of the manufacturer or distributor. In this case, the publishing user is a direct affiliate of the system operator, and the system operator is an affiliate of the manufacturer or distributor. In this case, the manufacturer or distributor will pass a commission to the system operator and the system operator will pass all or a portion of this commission to the publishing user. The sec publishing and user is in this case an indirect or sub-affiliate of the manufacturer or vendor.

In some embodiments, the publishing user gets a commission (directly or indirectly) from the manufacturer or distributor for all purchases made by the shopping user for a predetermined period of time, for example for every purchase within one month.

In some embodiments, the trade transaction is exchanging the apparel shown in the digital representation of the publishing user for another apparel in addition to a monetary payment.

In some embodiments, the tags comprise brand, size, color, price, type of apparel, fabric type, physical address of the store when the apparel was purchased, online store where the apparel was purchased, date purchased, product description or user review.

In some embodiments, the body type for females comprise inverted triangle, lean column, rectangle, apple, pear, neat hourglass and full hourglass.

In some embodiments, the body type for males comprise trapezoid, inverted triangle, rectangle, triangle and oval.

In some embodiments, the personal information comprise skin tone, face shape, hair color, hair length, eyes color, facial hair and age.

In some embodiments, the search is performed by entering any combination of free text, tags, selecting icons or through voice recognition.

In some embodiments, the search is performed by the system and a shopping user is shown photographs and/or videos most matching his body type and body measurements.

In some embodiments, a user opens a profile for another person.

In some embodiments, a user opens multiple profiles.

### BRIEF DESCRIPTION OF DRAWINGS

FIG. 1 is a flowchart of an exemplary process for becoming an online affiliate.

FIG. 2 is a flowchart of an exemplary process for the shopping process.

FIG. 3 is a flowchart of an exemplary process for acquiring links for uploaded apparel photographs.

FIG. 4 is a flowchart of an exemplary process for processing an image of an apparel.

### MODES FOR CARRYING OUT THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

The term “apparel” refers to any garment, clothing item, shoes or accessories including fashion items.

The term “accessories” refers to supplementary items serving as complements to an outfit, including but not limited to: a purse, belt, scarf, ribbon, hat or jewelry.

The term “digital representation” means a digital photograph a digital video, a link to a digital photo or a link to a digital video”.

The present invention relates to a computer-implemented method of enabling users to obtain an apparel via a trade transaction.

Initially, users sign-up via any computerized platform (PC, notebook computer, mobile phone, tablet and the like) and enter profile information comprising at least a masculine or feminine body type.

In some embodiments, users can also enter one, two, three or more body measurements such as chest, waist, hips and height measures.

Next, users can upload to a database digital representations showing them wearing at least one apparel on each digital representations. Users can then tag each digital representations they uploaded with one or more tags, such as brand, size, color, price, type of apparel, fabric type, physical address of the store when the apparel was purchased, online store where the apparel was purchased, date purchased, product description or user review.

When a user logs into the system, the system can search the database automatically for digital representations of apparels worn by other users with the most similar body type and body measurements. The system can also show the user articles that were searched and/or purchased by other users with similar preferences and behavior like the user (“crowd intelligence” techniques).

When a user logs into the system, the user can perform a search for an apparel. The system then searches the database for digital representations of the searched apparel (or similar apparel) worn by other users with the most similar body type and body measurements. The user can also enter tags into the search criteria, and the search will take the tags into account. In some embodiments, users can use free-text for searching apparels they are interested in. For example, “levi's 505”, “white bikini”, “black and white evening dress”, “slim-fit dress shirt with dark colors” etc.

When a user enters the system to browse/shop for an item (referred below or above as “online shopper” or “shopping user”) and sees a digital representation with an apparel he is interested in, the shopping user can obtain the apparel of the digital representation by performing a trade transaction. There are 3 types of possible trade transactions to obtain the apparel on the digital representations:

(1) The online shopper can access a link to the vendor of the apparel, and purchase any apparel from that vendor. A vendor can be the manufacturer, distributor or any entity selling the apparel. The online shopper may not necessarily purchase the exact same apparel he has seen in the digital representation. The online shopper may choose a different color, a different model or simply other choices offered by the same vendor. The user who uploaded the digital representation showing the apparel (referred herein as “publishing user”) has become an affiliate (or sub-affiliate) of the vendor and receives a commission from the vendor for all purchases of the online shopper with that vendor after accessing the link to the vendor from the user page. The commission received from the vendor can be directly (from vendor to user) or indirectly (from vendor to a commercial entity running the system of the invention and then to the user). The commercial entity can be an entity that runs the system or any other commercial entity. The commission can be any combination of monetary and credit commission. For example, the affiliate can receive money for any sales generated through his photographs and videos, or the user can receive a discount or credit with that vendor or both. For example, for a particular sale, the vendor may offer the affiliate either $20 cash or $30 credit for purchases with that vendor. The vendor may also offer the affiliate a present or a present and cash/credit.

(2) The online shopper may purchase the product directly from the user who uploaded the photograph.

(3) The online shopper can exchange the selected apparel with the user for a different apparel. For example, an online shopper who has seen a nice shirt may offer the owner to exchange it for a different shirt or a jacket. Optionally, the online shopper can offer the owner to add some money in addition to the exchange.

Any user in the system can be either of both of a publishing user and a shopping user. When a user uploads digital representations of apparels he wears or uses that user acts as a publishing user. When the user browses the system for apparel items worn by users matching his profile, that user is acting like a shopping user.

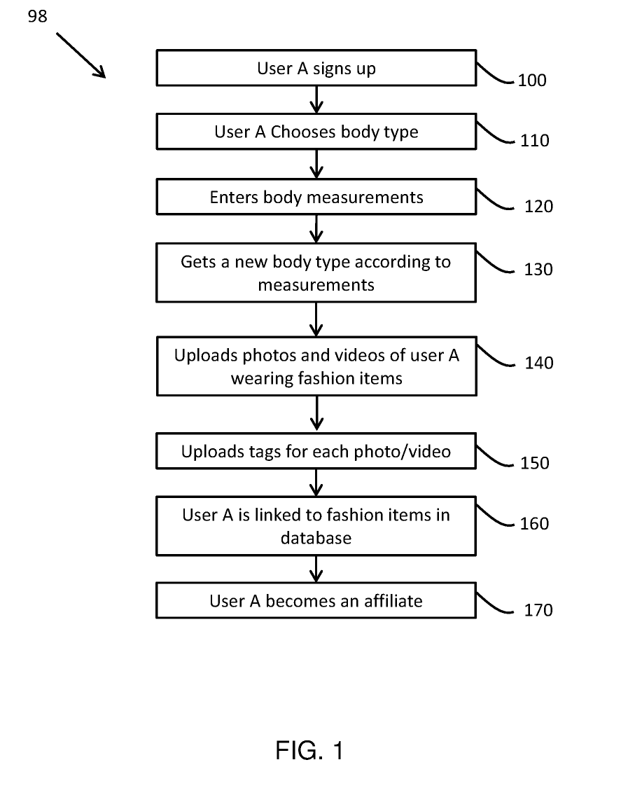

Reference is now made to FIG. 1, showing an embodiment of a process how an online shopper buys an apparel via an affiliate. The process starts in step 98.

In step 100, a user A (publishing user) signs up for the system providing his personal details such as gender, name (real and/or nickname) and email address.

In step 110, the user A chooses a body type. There are different body types for males and females as discussed in more detail further down.

In step 120, the user A enters his/hers body measurements comprising chest, waist, hips and height. It is also possible for a user to enter profile information of another person, for example, a wife wanting to shop for her husband. In some embodiments, a user may open several profiles.

In step 130, the system shows the user A an image of the user body type (as selected by the user in step 110) adapted to actual proportions in accordance with the body measures as entered in step 120.

In step 140, the user A can upload to a database photographs showing the user wearing at least one apparel. Optionally, the user A may also upload to the database videos showing the user A wearing an apparel.

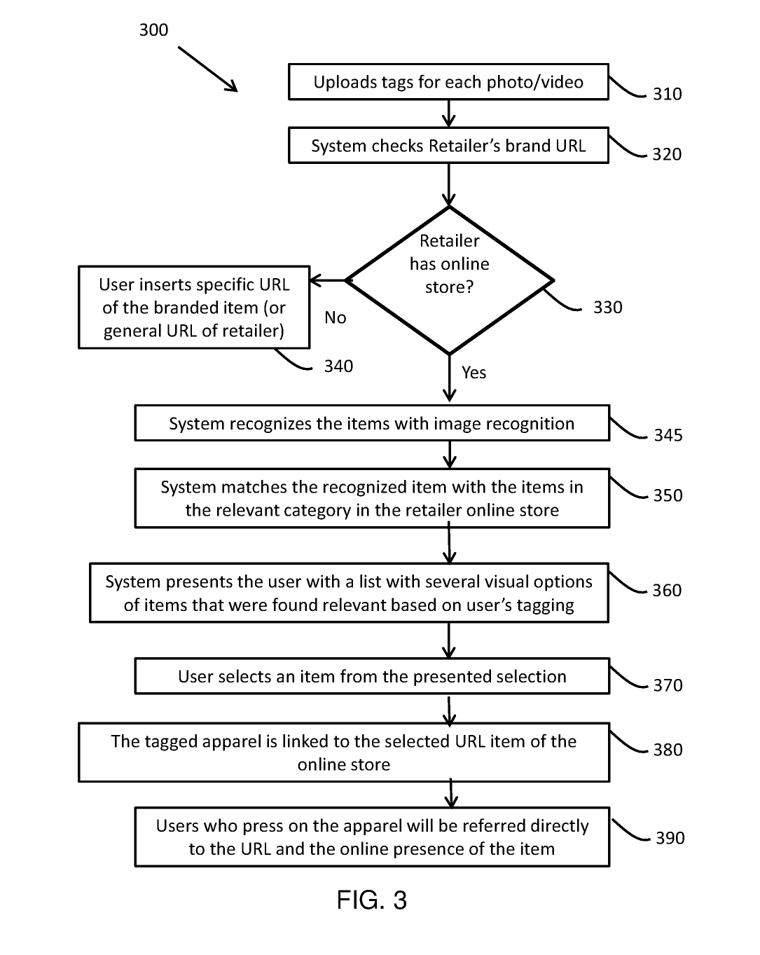

In step 150, the user A adds one or more tags to each photograph and video the user uploaded. Tags can be the brand, size, color, price, type of apparel, fabric type, physical address of the store when the apparel was purchased, online store where the apparel was purchased (URL address), date purchased, product description, user review or any other relevant piece of information. An embodiment of a process for acquiring a URL process into the system is shown in FIG. 3 and explained below.

In step 160, the system creates a fashion item (apparel) associated with the user, for each apparel the user has uploaded at least one photograph or video. Fashion items are stored in a database. A photo or video can show more than one apparel.

In step 170, the user A has become an affiliate. Preferably, the user A has identified the brand and/or vendor of the product so a link can be created to the vendor of the product.

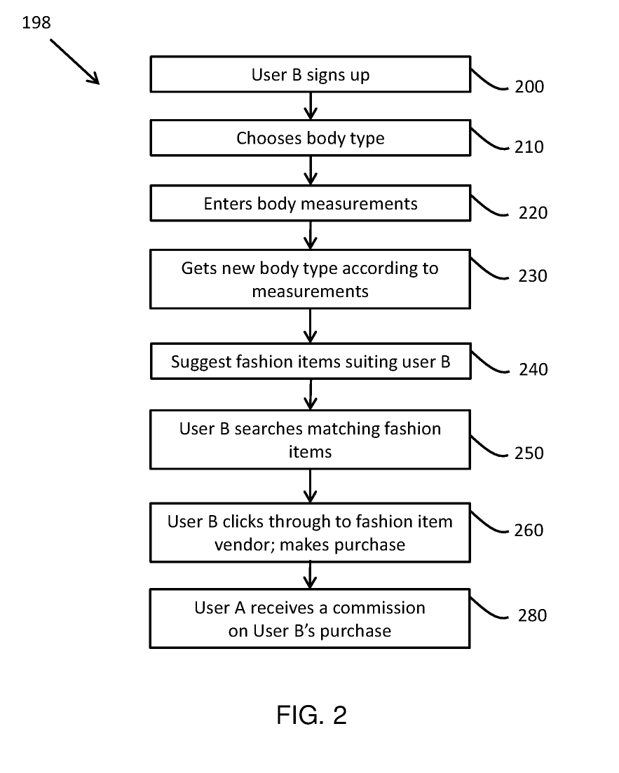

Reference is now made to FIG. 2 showing a flowchart of an exemplary process for the shopping process. In step 198 the process starts. Steps 200-260 describe the experience of users B,C,D as online shoppers (shopping users). Any user of the social network can both upload photographs/videos (act as a publishing user) and/or shop for apparels (act as a shopping user). A user can thus upload photographs/videos showing one or more apparels. A user can also shop online or a user can both upload photographs showing one or more apparels and also shop online.

In step 200, the user signs-up (if he has not signed up before in step 100) and provides his personal details such as gender, name (real and/or nickname) and email address.

In step 210, the user chooses a body type (if he has not chosen one before in step 110). There are different body types for males and females,

In step 220, the user enters his body measurements (if he has not entered them before in step 120). The body measurements comprise chest, waist, hips and height.

In step 230, the system shows the user an image of the user body type (as selected by the user in step 210 or 110) adapted to actual proportions in accordance with the body measures as entered in step 220 or 120.

In step 240, the system automatically suggests to online shoppers (users B, C or D) matching fashion items. The matching fashion items are photographs/videos of other users wearing at least one apparel, where whose body type and body measurements most match the body type and body measurements of the online shopper.

The online shopper can thus see how each apparel looks on somebody with a similar body to his. The system suggestions can also take into account personal preferences entered by the online shopper. For example, an online shopper might be interested in particular brands, in sports items, in business attire etc.

In step 250, online shoppers (users B, C or D) can search the database for matching fashion items. The matching fashion items are photographs of other users wearing at least one apparel, where whose body type and body measurements most match the body type and body measurements of the online shopper.

The online shopper can thus see how each apparel looks on somebody with a similar body to his. The search can also take into account other preferences entered by the online shopper. For example, an online shopper might be interested in particular brands, in sports items, in business attire etc.

In some embodiments, a user can open a profile in the system for another user, for example, a family member. In some embodiments, a user may open multiple profiles with the same user, for example, a mother opening profiles also for her husband and children so that she can also shop for them.

In some embodiments, the online shopper can search the database using free text. For example, “blue business suit”, “dry-fit Nike running shirts”, “red earrings”, “2-piece black swimsuit”, etc.

In some embodiments, the online shopper can search the database with any combination of free text and tags.

When searching for apparel shown by a user (user A) whose body type and optionally measures match the most the body type and measures of the online shopper (users B,C,D), the system can apply different algorithms and weights in order to suggest matches to the online shopper.

Example 1—when the body type of the online shopper and user A are identical, the following algorithm can apply:

MATCH score=30*CHEST-score+30*WAISTS-score+30*HIPS-score+10*HEIGHT-score.

The different body measures scores can be calculated in the following manner:

The default values of the 4 scores (chest, waists, hips and height) are 100%, and the following deductions apply:

CHEST-score—any deviation of 1 cm/0.4 in will deduct 10%;

WAISTS-score—any deviation of 1 cm/0.4 in will deduct 10%;

HIPS-score—any deviation of 1 cm/0.4 in will deduct 10%;

HEIGHT-score—any deviation of 1 cm/0.4 in will deduct 10%.

Example 2—when the body type of the online shopper and user A are different, the following algorithm can apply:

MATCH score=30*CHEST-score+30*WAISTS-score+30*HIPS-score+10*HEIGHT-score.

The different body measures scores can be calculated in the following manner:

The default values of the 4 scores (chest, waists, hips and height) are only 80%, and the following deductions apply:

CHEST-score—any deviation of 0.5 cm/0.2 in will deduct 10%;

WAISTS-score—any deviation of 0.5 cm/0.2 in will deduct 10%;

HIPS-score—any deviation of 0.5 cm/0.2 in will deduct 10%;

HEIGHT-score—any deviation of 1 cm/0.4 in will deduct 10%.

It should be noted that the matching algorithms examples above are given simply as one possible example, and the invention encompasses all algorithms, assigning different weights to these (or other) body measurements and giving different penalties to deviations from these (or other) body measurements.

In some embodiments, the matching process also takes into account personal features of the online shopper derived by analyzing his photos and/or as entered by the online shopper. For example, skin tone, face shape, hair color, hair length, eyes color, facial hair (beard, mustache) etc.

In some embodiments, the matching process also takes into account socio-demographic data about the online shopper (received from other sources, analyzed by the system and/or entered by the user himself). Such data may include age, country, hobbies etc.

In step 260, the online shopper (user B,C or D) wishes to purchase an apparel he saw on a photograph retrieved in steps 240 or 250. The online shopper then clicks on a link associated with that photograph and is transferred to the online store of the vendor of that apparel. The vendor can be the manufacturer, an authorized dealer or distributor or any online entity selling that apparel. Once the online shopper is at the online store of the vendor, the online shopper might purchase multiple products there including or excluding the origin apparel shown on the photograph.

In step 280, user A receives a commission from the system or vendor for all the purchases of the online shopper B in step 260. The commission may be in cash, store credit with the vendor, coupon, voucher, gift card or any other monetary (or monetary equivalent) compensation. In step 280, user A has become an affiliate of the vendor whose product he was promoting in the uploaded photograph, and user A thus receives a commission of all the purchases generated through his photographs on the system. The commissions can be for all purchases made by the online shopper within a predetermined period of time. For example, if the online shopper returns to make purchases within a month (of the first access), user A will also get a commission for the purchases of the online shopper.

The more information user A adds regarding an apparel on a digital representation the easier it becomes for online shoppers to appreciate the apparel and if it fits their needs, taste and life style. User A adds information about the apparel via tags. Tags can include brand name, size (so other users can see what would fit them), color (so a search may be done for a particular color of an apparel), price, type of apparel (shirt, sports shirt, business pants etc.), fabric type (cotton, synthetic, dry-fit etc.), physical address of the store when the apparel was purchased, online store where the apparel was purchased, date purchased (to see how old is the apparel on the photograph), product description or user review.

When user A uploads a photograph of an apparel in the system, it is important for him to add a link (URL address) to an online store where the apparel can be purchased by another user. Without providing the opportunity to purchase the apparel, user A cannot become an affiliate of the brand and cannot receive a compensation for the purchases he initiated.

One way a user may upload the apparel URL is manually finding the right URL, copying its address and then copy that address (or paste it) into the system. This process is very cumbersome (more so on a mobile phone with limited screen area) and the user may not always be able to easily locate the right URL.

Reference is made to FIG. 3 showing an exemplary process offering the user a semi-automatic process to create the right link to be associated with fashion item (apparel). In step 300 the process starts. In step 310 the user tags each uploaded photograph or video with appropriate tags such as the brand name, the item type and any other particular tag about the apparel. In step 320 the system verifies if the brand name is associated with a retailer URL (that is, the brand name has a proper Web site). Assuming so, the system continues to check in step 330 if the web site found in step 320 includes an online store (in some Web sites a user may only browse apparel items, while in others he may also purchase them online). If the retailer does not have an online store, the user may in step 340 select the general retailer URL or manually copy another URL (for example, another online store such as EBay™ where the apparel can be purchased).

If the retailer has an online store, the system can in step 345 apply one or more image recognition processes to identify the apparel the user has uploaded. Once identified, the system matches the found apparel with one or more similar items in the retail online store in step 350. In step 360 the system presents the user with one or more pictures of similar apparels that are estimated to be identical or close to the apparel the user has uploaded.

In step 370 the user chooses one of the presented pictures from the online store, to be associated with the photograph or video he has uploaded. In step 380 the tagged apparel item is linked to the URL of the selected picture, selected in step 370. In step 390 user B will be able to go directly to the URL associated with an apparel after selecting an apparel. The URL will enable user B to get more information about the apparel and make a purchase if desired.

The user (A) is thus able to upload a picture of video and select an online item (URL) to be associated with his apparel, without manually locating the URL or needing to copy the URL into the system.

Different body types are frequently referred to in the fashion industry. Female body types, may comprise: inverted triangle, lean column, rectangle, apple, pear, neat hourglass and full hourglass.
Inverted triangle—The bottom half is smaller than the top. Flat hips and bottoms. Straight and squared shoulder line. Little definition between waist and hips.
Lean Column—Narrow shoulders. Flat chest or small bust. Small and non-defined waist. Narrow hips and flat bottom.
Rectangle—Straight shoulder line and ribcage. Straight hips and bottom. Very little waist definition. Average tummy
Apple—Rounder shoulder line and flattish bottom. Average to big bust. Fullness around the middle. Good legs.
Pear—Full hips or thighs, maybe saddle bags. A defined waist. Shoulders that are narrower than the hips. A small top half as well as small bust.
Neat hourglass—A defined bust. A defined waist. A neat bottom. Neat hips.
Full hourglass—Bigger thighs. A rounded bottom and hips. A small waist. A full bust.

Male body types may comprise: trapezoid, inverted triangle, rectangle, triangle and oval.
The Trapezoid—reasonably broad set of shoulders and chest and a gentle taper from the top down through the waist, hips and legs.
The Inverted Triangle—chest and shoulders significantly broader than their waist and hips.
The Rectangle—Usually tall and thin, rectangular body shapes have shoulders roughly the same width as their waist and hips.
The Triangle—larger around the waist and hips and relatively narrow up top
The Oval—appear round, particularly at the center.

In some embodiments, a user views an apparel item on any web site and is interested in getting more information and/or potentially purchasing the apparel item. The user can then select (highlight) the apparel item via the system (via a widget, or by entering the system and pointing to the Web site with the desired apparel etc.). The selection is done by the system acquiring the link of the web page with the apparel via a system widget, entering the system and pointing to the Web site with the desired apparel, copying the Web site URL into the system or any other similar way to get the link of the web site into the system. Acquiring the link can be performed in many ways, for example, the user may manually copy the link and paste it in the application or the user can use a browser widget of the system or the user may enter the system and then select the desired link by navigating (from within the system) to the desired link. The item can also be acquired by taking a “screenshot” of the screen with the item and then searching for it in the system database using image recognition processes.

If the apparel is identified to be already present in the database of the system, the system can then present the users with pictures of other users with relevant profiles wearing this apparel. If there are no pictures of users with similar profiles (body types) wearing the exact apparel, the system may suggest viewing users with similar body types wearing a similar (but not the exact) apparel. If there are no pictures of users with similar profiles (body types) wearing a similar (but not the exact) apparel, the system may suggest viewing users (not necessarily with a defined body types) wearing a similar (but not the exact) apparel.

In some cases, the system may acquire a link to an apparel, but the link (apparel) will not be recognized in the system. The system then proceeds to perform an image recognition analysys on the apparel in order to identify identical or similar apparels in the system database. The matching (of identical or similar) apparels in the system can be done by comparing brands (if brand information is available), type of apparel (long sleeve shirt, short sleeve shirt, pants, bag etc.), shape, dominant color, texture and other parameters (stripes, material etc.). The user can then be presented with pictures of matching users wearing the (identical or similar) apparel, if such pictures are available in the system. If there are no pictures of users wearing the (identical or similar) apparel, the system may suggest viewing images (not necessarily of the systems' users) wearing a similar (but not the exact) apparel.

In some embodiments, a user views an apparel item on a real-world reference such as on shopping display window, a dressing room, a paper catalog or a paper newspaper and is interested in getting more information and/or potentially purchasing the apparel item or is interested to know how it looks on people with a similar body shape. The user can then select the apparel item via the system.

The selection can be done, for example, by taking a picture with the mobile phone camera. The user may open the application of the invention on his mobile phone and then take a picture of the apparel (in the catalog, newspaper or any other publication). Alternatively, the user may simply take a picture of the apparel and then via the application of the invention, access the photo from the photo gallery (or any other photo location) on the phone. In some embodiments, the user may select a photo with an apparel, after receiving the photo via email or any other messaging service.

In such scenarios as described above, the user selects via the application a picture of an apparel he is interested to get more information about and/or intends to find purchasing information about it, for example, brand, shape, product information (materials, usage information etc.) and pricing.

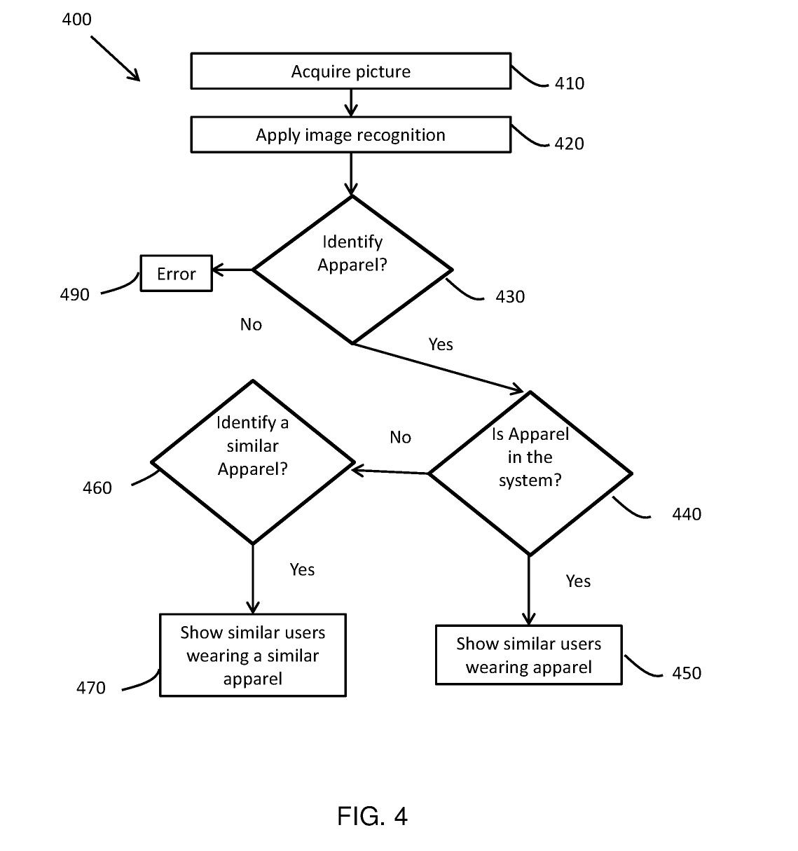

Reference is now made to FIG. 4 showing an examplary process of getting more information from an image of an apparel. In step 400, the process starts. In step 410, the system acquires an image as disclosed above from a real-word reference (such as catalog, magazine, newspaper, flyer, store window, dressing room etc.). In step 420, the system applies image recognition algorithm(s) of the art in order to identify the apparel in the picture (photograph).

If an apparel is identified in the picture in step 430, the system checks in step 440 if the apparel is found in the system. If the apparel is found in the system, the system proceeds in step 450 to show the user pictures of other users with similar body types wearing the apparel. If no apparel can be identified in the picture in step 430, the system shows an error message in step 490 telling the user that it could not identify an apparel in the acquired image. Such errors can be caused, for example, by low quality images that may be blurry, with bad lighting, where the apparel is hardly distinguished from the background etc.

If in step 440 if the apparel is not found in the system, the system then tries to identify similar apparels (same type of apparel, brand, color etc.) in step 460. If similar apparels are found, the proceeds in step 470 to show the user pictures of similar users with similar body types wearing the identified similar apparel.

Although the invention has been described in detail, nevertheless changes and modifications, which do not depart from the teachings of the present invention, will be evident to those skilled in the art. Such changes and modifications are deemed to come within the purview of the present invention and the appended claims.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media in a number of manners. In some embodiments, hard-wired circuitry or custom hardware may be used in place of, or in combination with, software instructions for implementation of the processes of various embodiments. Thus, embodiments are not limited to any specific combination of hardware and software.

A “processor” means any one or more microprocessors, central processing units (CPUs), computing devices, microcontrollers, digital signal processors, or like devices.

The term “computer-readable medium” refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

1.-43. (canceled)

44. A computing system comprising:
at least one processor; and
at least one memory communicatively coupled to the at least one processor comprising computer-readable instructions that when executed by the at least one processor cause the computing system to implement a method of enabling users to purchase an apparel online, the method comprising:
(i) receiving user profile information of a shopping user comprising at least a masculine or feminine body type;
(ii) receiving in a database digital representations uploaded by one or more publishing users, each digital representation associated with a publishing user and showing the publishing user wearing at least one apparel;
(iii) associating each digital representation with one or more tags; and
(iv) based on a matching criteria, showing the shopping user, a digital representation of an apparel worn by at least one matching publishing user of the publishing users, the matching criteria comprising one or more of personal information, body type and the one or more tags.

45. The computing system of claim 44, wherein the method further comprising:
(v) presenting the shopping user an online shopping module to purchase online at least one apparel from a vendor associated with the apparel shown in the digital representation of the publishing user; and
(vi) rewarding the publishing user financially for the purchase of the shopping user.

46. The computing system of claim 44, wherein user profile information comprises at least one body measurement.

47. The computing system of claim 44, wherein the publishing user is rewarded for one or more purchases made by the shopping user within a predetermined period of time.

48. The computing system of claim 44, wherein said at least one apparel comprise the apparel shown in said digital representation.

49. The computing system of claim 44, wherein said one or more tags are selected from a group comprising: brand, size, color, price, type of apparel, fabric type, physical address of the store when the apparel was purchased, online store where the apparel was purchased, date purchased, product description or user review.

50. The computing system of claim 44, wherein the personal information comprises one or more of: skin tone, face shape, hair color, hair length, eyes color, facial hair and age.

51. The computing system of claim 44, wherein matching publishing users are identified by entering any combination of free text, tags and icon selection.

52. The computing system of claim 44, wherein the system applies imaging recognition processes on the digital representation in order to identify an apparel.

53. The computing system of claim 52, further comprising the step of searching the database for a match of the identified apparel.

54. The computing system of claim 52, further comprising the step of searching an online store for one or more items that match of the identified apparel.

55. The computing system of claim 54, further comprising the step of showing the publishing user said one or more items and receiving the publishing user selection identifying the item that matches the identified apparel and associating the URL of the selected item with the digital representation of the identified apparel.

56. The computing system of claim 44, wherein the apparel includes an accessory.

57. A computing system comprising:
at least one processor; and
at least one memory communicatively coupled to the at least one processor comprising computer-readable instructions that when executed by the at least one processor cause the computing system to implement a method of enabling users to obtain an apparel via a trade transaction, the method comprising:
(i) receiving user profile information comprising at least a masculine or feminine body type;
(ii) receiving in a database digital representations uploaded by one or more publishing users, each digital representation associated with a publishing user and showing the publishing user wearing at least one apparel;
(iii) associating each digital representation with one or more tags;
(iv) based on a matching criteria, showing a shopping user, associated with the user profile information, a digital representation of an apparel worn by a matching publishing user of the publishing users, the matching criteria comprising one or more of personal information, body type and the one or more tags;
(v) enabling the shopping user to obtain at least one apparel associated with the apparel shown in the digital representation of the publishing user by performing a trade transaction.

58. The computing system of claim 57, wherein user profile information comprises at least one body measurement to their profile information.

59. The computing system of claim 57, wherein the trade transaction is purchasing the apparel from the publishing user.

60. The computing system of claim 57, wherein the trade transaction is purchasing one or more apparel from the manufacturer or distributor of the apparel shown in said digital representation.

61. The computing system of claim 60, wherein said one or more apparel comprise the apparel shown in said digital representation.

62. The computing system of claim 60, wherein the publishing user gets at least one commission from said manufacturer or distributor or from the system operator for more or more purchases made by the shopping user within a predetermined period of time.

63. The computing system of claim 57, wherein said one or more tags are selected from a group comprising: brand, size, color, price, type of apparel, fabric type, physical address of the store when the apparel was purchased, online store where the apparel was purchased, date purchased, product description or user review.

64. The computing system of claim 57, wherein the personal information comprises one or more of: skin tone, face shape, hair color, hair length, eyes color, facial hair and age.
